(19) United States
(12) Patent Application Publication
(10) Pub. No.: US 2013/0254140 A1
(43) Pub. Date: Sep. 26, 2013

(54) METHOD AND SYSTEM FOR ASSESSING AND UPDATING USER-PREFERENCE INFORMATION

(71) Applicants: Jianguo Li, Chicago, IL (US); Paul C. Davis, Arlington Heights, IL (US); Guohua Hao, Forest Hills, NY (US)

(72) Inventors: Jianguo Li, Chicago, IL (US); Paul C. Davis, Arlington Heights, IL (US); Guohua Hao, Forest Hills, NY (US)

(73) Assignee: GENERAL INSTRUMENT CORPORATION, Horsham, PA (US)

(21) Appl. No.: 13/424,959

(22) Filed: Mar. 20, 2012

(51) Int. Cl. G06F 15/18

(52) U.S. Cl. 706/12

(57) ABSTRACT

Disclosed are a variety of methods and systems for processing access-only user-behavior data and developing and using user-preference models. In one example embodiment, a method for ascribing a score to a first portion of preference data includes establishing a model of user-preference data and receiving the first portion of preference data at a first computerized device and storing that data. The method further includes calculating at least one statistic in relation to the first portion of the preference data by way of a processing device of either the first computerized device or a second computerized device and performing at least one additional operation, by way of either the processing device or another processing device, by which the at least one statistic is evaluated in relation to the model, whereby as a result of being evaluated, the at least one statistic is converted into the score.

### FIELD OF THE INVENTION

The present invention is related generally to behavior analysis or prediction and, more particularly, to methods, techniques, models, devices, or systems for determining, measuring, predicting, or utilizing preferences or profiles of individuals or users, including among other things updating such preferences or profiles or models of same, as well as to providing profiling, personalization and recommendation services and capabilities more generally.

### BACKGROUND OF THE INVENTION

User-preference models, which are built upon a set of preference data, are designed to predict a user's preferences on new data. In some circumstances, where a preference module involves assigning scores based upon a pre-defined rating system (e.g., a rating scale from 1 to 5, where 5 indicates strong preference and 1 strong dislike), the results can be semantically meaningful outside of a ranking scenario. However, there are many circumstances in which there are data regarding user activity but where the data do not include explicit or implicit rankings information from the users. The data available in this regard can in at least some circumstances be referred to as “access-only” data since the data may only be reflective of the fact that a given user (or users) selected or came into contact with a given item or portion of information, that is, access-only data refers to preference data where users do not explicitly indicate their preferences for any given data point (and there is no or little additional information for inferring users' preferences implicitly either).

Although in some cases access-only data can occur in a manner indicating only that a user (or users) came into contact with data, in some other cases access-only data also can contain some limited information about the context of the contact, for example the time or date the contact occurred or how often a user (or users) came into contact with the data (frequency of contact). When there is such additional limited information, such information can in some cases be used to improve ranking and preference modeling. Also, when there is contextual information, it can in some cases be used for inferring rankings and preferences about a given context.

Regardless of the exact nature of such access-only data, although such access-only data can be utilized to develop a preference model, such data can typically only be used to compute similarity scores, which in turn can be used for ranking new data items. However, the scores produced by such methods typically are not meaningful beyond this ranking.

### BRIEF SUMMARY

The above considerations, and others, are addressed by the present invention, which can be understood by referring to the specification, drawings, and claims. According to aspects of the present invention, in one example embodiment, a method of ascribing a score to a first portion of preference data includes establishing a model of user-preference data and receiving the first portion of preference data at a first computerized device and storing the first portion of preference data in a memory device associated with the first computerized device. The method further includes calculating at least one statistic in relation to the first portion of the preference data by way of a processing device of either the first computerized device or a second computerized device in communication with the first computerized device and performing at least one additional operation, by way of either the processing device or another processing device, by which the at least one statistic is evaluated in relation to the model, whereby as a result of being evaluated the at least one statistic is converted into the score.

Also, in another example embodiment, the present invention relates to a method of establishing a preference model that can be utilized for ascribing a score to a first portion of preference data. The method includes collecting a plurality of first portions of preference data at a first computerized device and storing the portions of preference data in one or more memory devices associated with the first computerized device and developing a first prototype based upon the portions of preference data, where the prototype is a data aggregation based at least in part upon each of the portions of the preference data. The method further includes calculating, by way of a processing device of the first computerized device, at least one first statistic in relation to each respective one of the portions of preference data and performing at least one mapping operation in relation to the statistics so as to complete the establishing of the preference model.

Further, in another example embodiment, the present invention relates to a system configured for processing access-only user-behavior data. The system includes at least one input device by which a plurality of first preference data portions are received and at least one memory device at least indirectly coupled to the at least one input device, the at least one memory device being configured to store the first preference data portions. The system further includes at least one processing device at least indirectly coupled to each of the at least one input device and the at least one memory device, the at least one processing device being configured to determine a first prototype based upon the first preference data portions and further configured to determine a plurality of first statistics in relation to the first preference data portions. Based upon the first prototype and the first statistics, a scoring scale is developed by which similarity scores can be converted based upon further processing of the at least one processing device to have semantically meaningful scores.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 shows in schematic form an example communications system involving a plurality of mobile devices in communication with a plurality of content provider websites, where some communications occur via an intermediary web server;

FIG. 2 is a block diagram showing example components of one of the mobile devices of FIG. 1;

FIG. 3 is a block diagram showing example components of the intermediary web server of FIG. 1;

FIGS. 4, 7, and 8 are flow charts showing various steps of example processes that can be performed by one or more of the devices of FIG. 1, the processes relating to developing preference models, performing scoring based upon such preference models, and updating such preference models; and

FIGS. 5 and 6 are further schematic diagrams illustrating aspects relating to the preference models that can be developed, utilized, or updated in accordance with the processes represented by the flow charts of FIGS. 4, 7, and 8.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

The present disclosure relates to a number of methods, techniques, models, devices, and systems for assessing user preferences or profiles. To begin, in at least some embodiments, the present disclosure involves methods or systems for assessing user preferences that allow for conversion and distribution of similarity scores into scores on a semantically meaningful rating scale so that a data point can be easily categorized and communicated, where the distribution of the scored items aligns with expected results. By doing this, it becomes possible for the scores to be both easily interpreted and relied on for further computation.

In at least some such embodiments, the method involves inferring scored preferences from accessed data. In such embodiments, the method relies on a preference model which captures a user preference (e.g., the preferences of one user or multiple users) with a set of statistics and a prototype (e.g., an example aggregated from all the available preference data, on a feature basis—further for example, for each feature there is an aggregation component). Similarity scores between each data point from a user's history (or multiple such users' histories) and such a prototype are computed in order to obtain statistics representing the distribution of user preferences with respect to such a prototype. Crucially, these statistics record what are the possible similarities given the data set. For example, in one example embodiment, the minimum possible and maximum possible similarity statistics are recorded (additional or different statistics could be used in other embodiments). These statistics then provide an insight into how much is known about the user via the data and provide a framework for distributing the scores in a meaningful way relative to the amount and informativeness of the data available. Accordingly, when a new data point comes in, its similarity score to such a prototype is assumed to follow the same distribution, and therefore a mapping function is used to redistribute the similarity score into a score on a semantically meaningful rating scale (e.g., a rating scale from 1 to 5, where 5 indicates strong preference and 1 strong dislike) by taking into account the distribution information of user preferences stored in the preference model.

The above described manner of establishing user preferences is advantageous in a number of respects. The user-preference models generated in this manner can be useful to infer scored preferences, which are semantically meaningful, and can be employed in a variety of user profiles or models and recommender systems (e.g., systems for recommending video, music, advertisements, news, and the like). Also, such methodologies for establishing user preferences are advantageous in that the methodologies can improve scalability notwithstanding the storing of user-behavior data directly. Among other things, by making the preference models more compact, the preference models can store prototypes extracted from available user-behavior data as well as some additional statistics which describe the distribution of user preferences with respect to such prototypes. In addition, because this manner of establishing user preferences generates semantically meaningful ratings, the user-preference models generated in this manner can also be used and combined with explicit preferences or ratings, or inferred or implicit preferences or ratings, since the various ratings and preferences are semantically compatible.

Even with such techniques, however, updating the model with new data can also be problem in terms of efficiency, because statistics may need to be calculated with reference to all of the data points from which the model is derived. More particularly in this regard, storing all the available user-behavior data in order to update user-preference models can require major amounts of hardware storage space, which can be cost-prohibitive. Also, updating user-preference models using all the available user-behavior data can be time-consuming and can require significant computing resources. Thus, even though user-preference models can be used to infer scored preferences in manners such as those mentioned above, as more and more user-behavior data are collected, such a brute force manner of computing these user-preference models based on all the available user-behavior data takes a longer time to finish, and therefore this process itself does not necessarily scale well.

Given such concerns, in at least some embodiments, the present disclosure also relates to methods or systems for efficiently updating inferred preference models of users. In at least some such embodiments, such a method involves efficiently updating the preference models, as new user-behavior data are collected, by incrementally updating the prototype and related statistics based on those newly collected behavior data only (in conjunction with the existing preference models). As a result, by avoiding looking through all the previous user-behavior data, this method makes the update of preference models very efficient and again improves scalability relative to what would otherwise be afforded. Thus, embodiments such as those mentioned above or discussed in more detail below can be employed in a variety of roles and applications including, for example, as part of profiling, personalization, recommendation, and user modeling technologies that can be implemented in a variety of manners (with a variety of uses) in many different types of mobile devices as well as implemented in other devices such as web server computer systems that either provide content to users or serve as intermediaries between such content providers and clients of such content providers, which again in some cases can be mobile devices or other computerized devices.

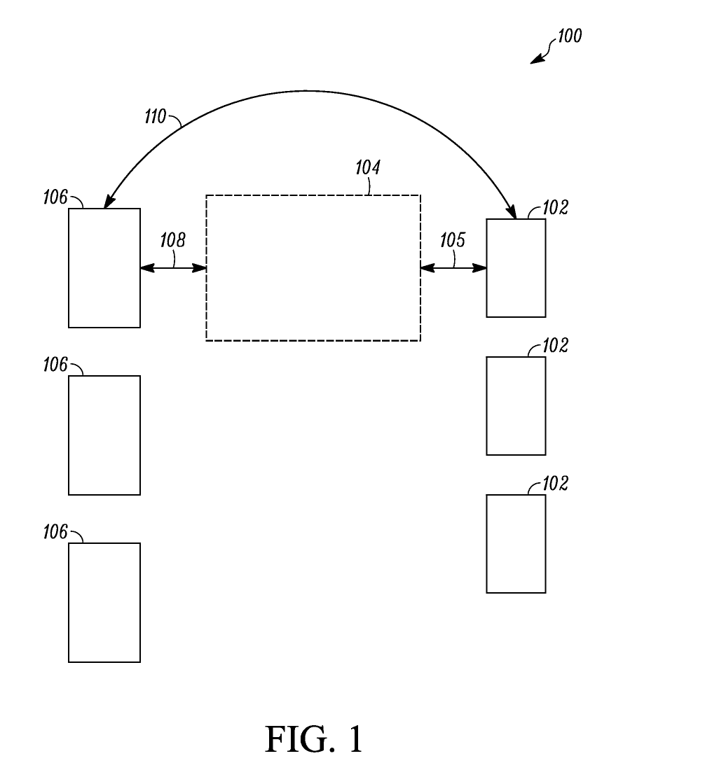

Referring to FIG. 1, an example communications system 100 is shown in a simplified schematic form. As discussed further below, the communications system 100 or one or more components thereof in at least some embodiments are configured to operate in accordance with one or more methods, techniques, or models, or configured to include one or more devices or systems, for determining, measuring, predicting, or utilizing preferences or profiles of individuals or users (including among other things updating such preferences or profiles or models, as well as providing profiling, personalization, and recommendation services and capabilities more generally). As shown, the communications system 100 in this embodiment particularly includes three mobile devices 102, one of which is shown to be in communication via a communication link 105 with a server, which in the present embodiment is a web server 104. The mobile devices 102 are respectively representative of communication devices operated by persons (or users) or possibly by other entities (e.g., netbooks or other computers) desiring or requiring communication capabilities. In some embodiments, for example, the mobile devices can be any of cellular telephones, other wireless devices such as personal digital assistants, or devices such as laptops and desktop computers that are capable of connecting to and communicating with a network.

The communications system 100 additionally is shown to include three content provider websites (CPWs) 106, one of which is shown to be in communication with the intermediary web server 104 via a communication link 108. Further, a communication link 110 is also provided that allows for the mobile device 102 that is in communication with the web server 104 to directly communicate with the CPW 106 that is also in communication with the web server 104, without the intermediation of the web server 104. Although only one of the mobile devices 102 and one of the CPWs 106 are shown in to be in communication with the web server 104, it will be understood that depending upon the time or operational circumstance, any or all of the mobile devices 102 and CPWs 106 can be in communication with the web server 104. Likewise, depending upon the time or operational circumstance, any of the mobile devices 102 can enter into communication with any of the CPWs 106 by way of direct communication links such as the link 110. The CPWs 106 are intended to encompass and be representative of any of a variety of different types of websites that are configured to offer or provide content including, for example, social networking websites, news feeds, music and photograph websites, as well as other types of websites such as business-to-business or business-to-consumer websites. Depending upon the embodiment, the CPWs 106 can be interactive websites that allow for the downloading or uploading (e.g., posting) of various forms of data, such as news, weather, personal or business information, pictures, videos, and songs and thereby facilitate the creation and maintaining of interpersonal connections among persons and groups of persons. It should also be understood that any and all of the types of content provided by the CPWs 106 can also, depending upon the embodiment, be provided by one or more other devices, mechanisms, systems, or sources not shown in FIG. 1, or by any of the other devices shown in FIG. 1 (e.g., the web server 104 or any of the mobile devices 102) themselves. For example, the content available to a device (e.g., one of the mobile devices 102) can be stored on the device itself. For example, the device can contain collections of music or videos or any other type of content similar to what can be obtained by way of the CPWs 106. Similarly, content can also be provided by other devices or distributed among various combinations of CPWs 106, servers, and other devices.

Although three mobile devices 102 are shown in FIG. 1, in other embodiments only one mobile device 102 is present in communication with the web server 104 or alternatively any arbitrary number of mobile devices 102 can be in communication with the web server 104. Likewise, although three CPWs 106 are shown in FIG. 1, in other embodiments only one CPW 106 is in communication with the web server 104, or alternatively any arbitrary number of CPWs 106 can be in communication with the web server 104. Additionally, any arbitrary number of mobile devices 102 can be in communication with any arbitrary number of CPWs 106 by way of direct communication links such as the link 110 in other embodiments. That is, FIG. 1 is intended to be representative of any of a variety of systems employing any arbitrary number of mobile devices 102 and any arbitrary number of CPWs 106 that are in communication with one another either indirectly via a web server interface or directly with one another.

Depending upon the embodiment, the communication links 105, 108, 110 can be part of a single network or multiple networks, and each link can include one or more wired or wireless communication pathways, for example, landline (e.g., fiber optic, copper) wiring, microwave communication, radio channel, wireless path, intranet, Internet, or World Wide Web communication pathways (which themselves can employ numerous intermediary hardware or software devices including, for example, routers, etc.). In addition, a variety of communication protocols and methodologies can be used to conduct the communications via the communication links 105, 108, 110 between the mobile devices 102, web server 104, and CPWs 106, including for example, transmission control protocol/internet protocol, extensible messaging and presence protocol, file transfer protocol, etc. In other embodiments, other types of communication links for facilitating the transfer of signals between the plurality of mobile devices 102 and the CPWs 106 can be utilized as well. Although in the present embodiment the communication links and networks and the server 104 are each discussed as being web-based, in other embodiments, the links and networks and server 104 can assume various non-web-based forms.

In the present embodiment, the web server 104 is configured to serve as an intermediary between the mobile devices 102 and the CPWs 106. Various types of communications between the mobile devices 102 and CPWs 106 are passed through, processed, or monitored by the web server 104 including, for example, communications involving the uploading and downloading of files (e.g., photos, music, videos, text entries, etc.), blog postings, and messaging (e.g., Short Message Service, Multimedia Messaging Service, and Instant Messaging). The CPWs 106 are generally intended to encompass a variety of interactive websites that allow for the downloading and uploading (e.g., posting) of various forms of data, such as personal or business information, pictures, videos, and songs and thereby facilitate the creation and maintaining of interpersonal connections among persons and groups of persons. Examples of CPWs 106 include, for example, Facebook™, MySpace™, hi5™, LinkedIn™, and Twitter™. For purposes of the present invention, CPWs 106 can also be understood to encompass various other types of websites (e.g., business-to-business or business-to-consumer websites) that, while not focused entirely or predominantly upon social networking, nevertheless also include social networking-type features. Other content provider websites include sources of RSS or other news feeds, photograph services such as Picasa™ or Photobucket™, and music services such as LastFM™.

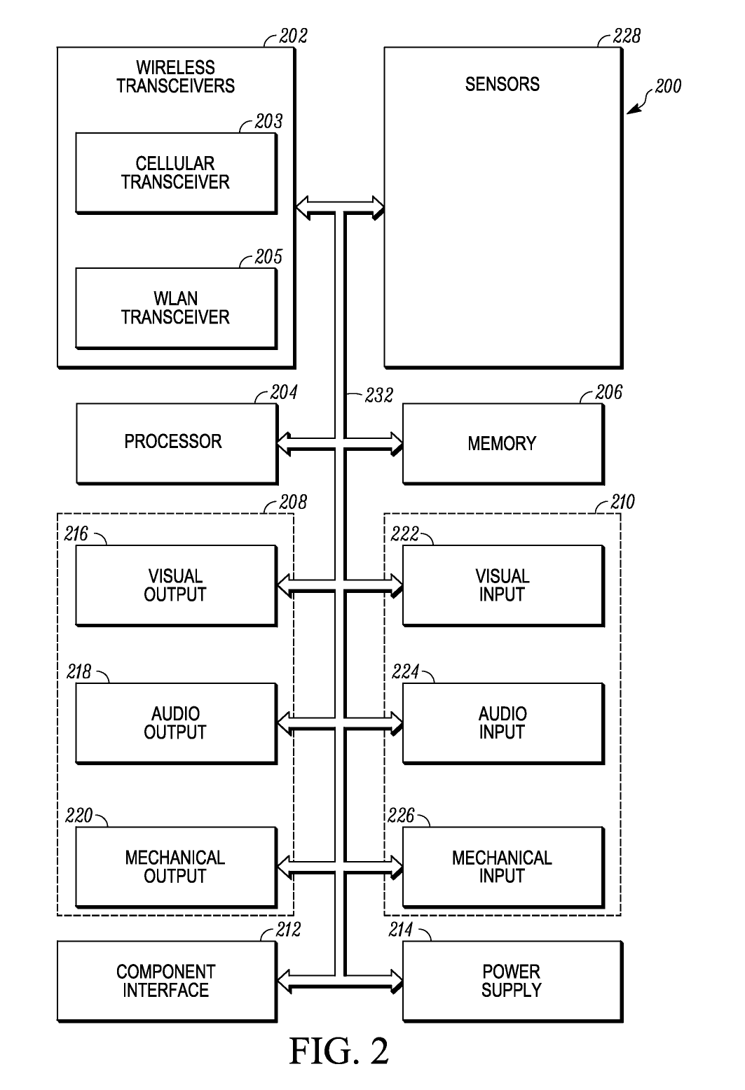

Referring to FIG. 2, a block diagram illustrates example internal components 200 of a mobile device such as the mobile device 102 in accordance with the present embodiment. As shown in FIG. 2, the components 200 include one or more wireless transceivers 202, a processor portion 204 (e.g., a microprocessor, microcomputer, application-specific integrated circuit, etc.), a memory portion 206, one or more output devices 208, and one or more input devices 210. In at least some embodiments, a user interface is present that comprises one or more output devices 208, such as a display, and one or more input device 210, such as a keypad or touch sensor. The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile device 102 to be portable. All of the internal components 200 can be coupled to one another, and in communication with one another, by way of one or more internal communication links 232 (e.g., an internal bus).

In the present embodiment of FIG. 2, the wireless transceivers 202 particularly include a cellular transceiver 203 and a Wi-Fi transceiver 205. More particularly, the cellular transceiver 203 is configured to conduct cellular communications, such as 3G, 4G, 4G-LTE, etc., vis-à-vis cell towers (not shown), albeit in other embodiments, the cellular transceiver 203 can be configured instead or additionally to utilize any of a variety of other cellular-based communication technologies such as analog communications (using AMPS), digital communications (using CDMA, TDMA, GSM, iDEN, GPRS, EDGE, etc.), or next generation communications (using UMTS, WCDMA, LTE, IEEE 802.16, etc.) or variants thereof.

By contrast, the Wi-Fi transceiver 205 is a wireless local area network (WLAN) transceiver 205 configured to conduct Wi-Fi communications in accordance with the IEEE 802.11 (a, b, g, or n) standard with access points. In other embodiments, the Wi-Fi transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the Wi-Fi transceiver 205 can be replaced or supplemented with one or more other wireless transceivers 202 configured for non-cellular wireless communications including, for example, wireless transceivers 202 employing ad hoc communication technologies such as HomeRF (radio frequency), Home Node B (3G femtocell), Bluetooth, or other wireless communication technologies such as infrared technology. Thus, although in the present embodiment the mobile device 102 has two of the wireless transceivers 203 and 205, the present disclosure is intended to encompass numerous embodiments in which any arbitrary number of (e.g., more than two) wireless transceivers 202 employing any arbitrary number of (e.g., two or more) communication technologies are present.

Example operation of the wireless transceivers 202 in conjunction with others of the internal components 200 of the mobile device 102 can take a variety of forms and can include, for example, operation in which, upon reception of wireless signals, the internal components 200 detect communication signals, and the transceiver 202 demodulates the communication signals to recover incoming information, such as voice or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceivers 202 convey the modulated signals by way of wireless and (possibly wired as well) communication links to other devices such as the web server 104 and one or more of the CPWs 106 (as well as possibly to other devices such as a cell tower, access point, or another server or any of a variety of remote devices).

Depending upon the embodiment, the input and output devices 208, 210 of the internal components 200 can include a variety of visual, audio, or mechanical outputs. For example, the output devices 208 can include one or more visual output devices 216 such as a liquid crystal display and light emitting diode indicator, one or more audio output devices 218 such as a speaker, alarm, or buzzer, or one or more mechanical output devices 220 such as a vibrating mechanism. The visual output devices 216 among other things can include a video screen. Likewise, by example, the input devices 210 can include one or more visual input devices 222 such as an optical sensor (for example, a camera), one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical actuation of buttons or other actuators but can also include, for example, opening the mobile device 102 (if it can take on open and closed positions), unlocking the device 102, moving the device 102 to actuate a motion, moving the device 102 to actuate a location positioning system, and operating the device 102.

As shown in FIG. 2, the internal components 200 of the mobile device 102 also can include one or more of various types of sensors 228. The sensors 228 can include, for example, proximity sensors (a light-detecting sensor, an ultrasound transceiver, or an infrared transceiver), touch sensors, altitude sensors, a location circuit that can include, for example, a Global Positioning System receiver, a triangulation receiver, an accelerometer, a tilt sensor, a gyroscope, or any other information collecting device that can identify a current location or user-device interface (carry mode) of the mobile device 102. Although the sensors 228 are for the purposes of FIG. 2 considered to be distinct from the input devices 210, in other embodiments it is possible that one or more of the input devices 210 can also be considered to constitute one or more of the sensors 228 (and vice-versa). Additionally, even though in the present embodiment the input devices 210 are shown to be distinct from the output devices 208, it should be recognized that in some embodiments one or more devices serve both as input devices 210 and output devices 208. For example, in embodiments where a touchscreen is employed, the touchscreen can be considered to constitute both a visual output device 216 and a mechanical input device 226.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. In some embodiments, the memory portion 206 can be integrated with the processor portion 204 in a single device (e.g., a processing device including memory or processor-in-memory), albeit such a single device will still typically have distinct sections that perform the different processing and memory functions and that can be considered separate devices.

The data that are stored by the memory portion 206 can include, but need not be limited to, operating systems, applications, and informational data. Each operating system includes executable code that controls basic functions of the communication device 102, such as interaction among the various components included among the internal components 200, communication with external devices via the wireless transceivers 202 or the component interface 212, and storage and retrieval of applications and data to and from the memory portion 206. Each application includes executable code that utilizes an operating system to provide more specific functionality for the communication devices 102, such as file system service and handling of protected and unprotected data stored in the memory portion 206. Informational data is non-executable code or information that can be referenced or manipulated by an operating system or application for performing functions of the communication device 102.

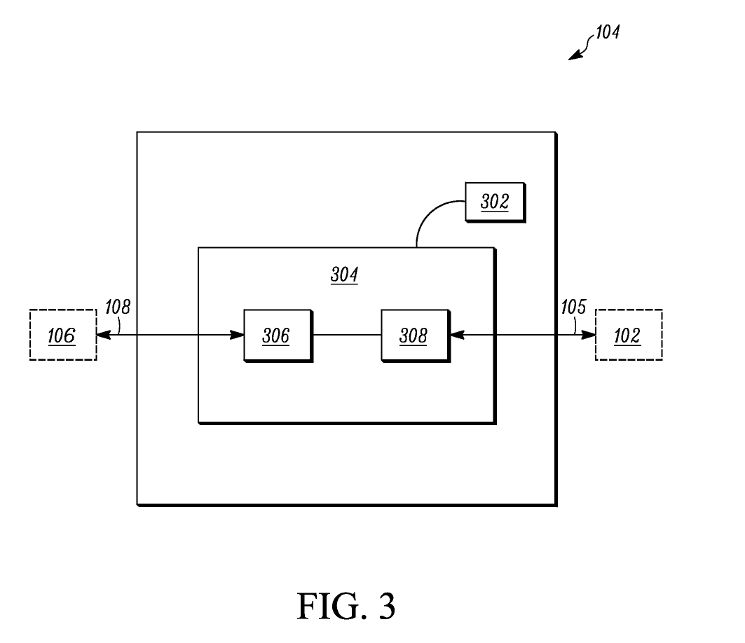

Referring next to FIG. 3, additional example components of the web server 104 of FIG. 1 are shown in more detail. As shown, the web server 104 includes a memory portion 302, a processor portion 304 in communication with that memory portion 302, and one or more input/output interfaces (not shown) for interfacing the communication links 105, 108 with the processor 304. The processor portion 304 further includes a back-end portion 306 (or Social Network Processor) and a front-end portion 308. The back-end portion 306 communicates with the CPWs 106 (shown in dashed lines) via the communication link 108, and the front-end portion 308 communicates with the mobile devices 102 (also shown in dashed lines) via the communication link 105.

In at least some embodiments the back-end portion 306 supports pull communications with CPWs such as the CPW 106. The pull communications can, for example, be implemented using Representation State Transfer architecture, of the type typical to the web, and as such the back-end portion 306 is configured to generate requests for information to be provided to the back-end portion 306 from the CPWs 106 at times or circumstances determined by the web server 104, in response to which the CPWs 106 search for and provide to the web server 104 the requested data. Also as discussed in further detail below, in at least some embodiments the front-end portion 308 establishes a push channel in conjunction with mobile devices such as the mobile device 102.

In at least some such embodiments, the push channel allows the front-end portion 308 to provide notifications from the web server 104 (generated by the front-end portion 308) to the mobile device 102 at times and circumstances determined by the web server 104. The notifications can be indicative of information content that is available to be provided to the mobile device 102. The mobile device 102 in turn is able to respond to the notifications, in a manner deemed appropriate by the mobile device 102. Such responses often (but not necessarily always) constitute requests that some or all of the available information content be provided from the front-end portion 308 of the intermediary web server 104 to the mobile device 102.

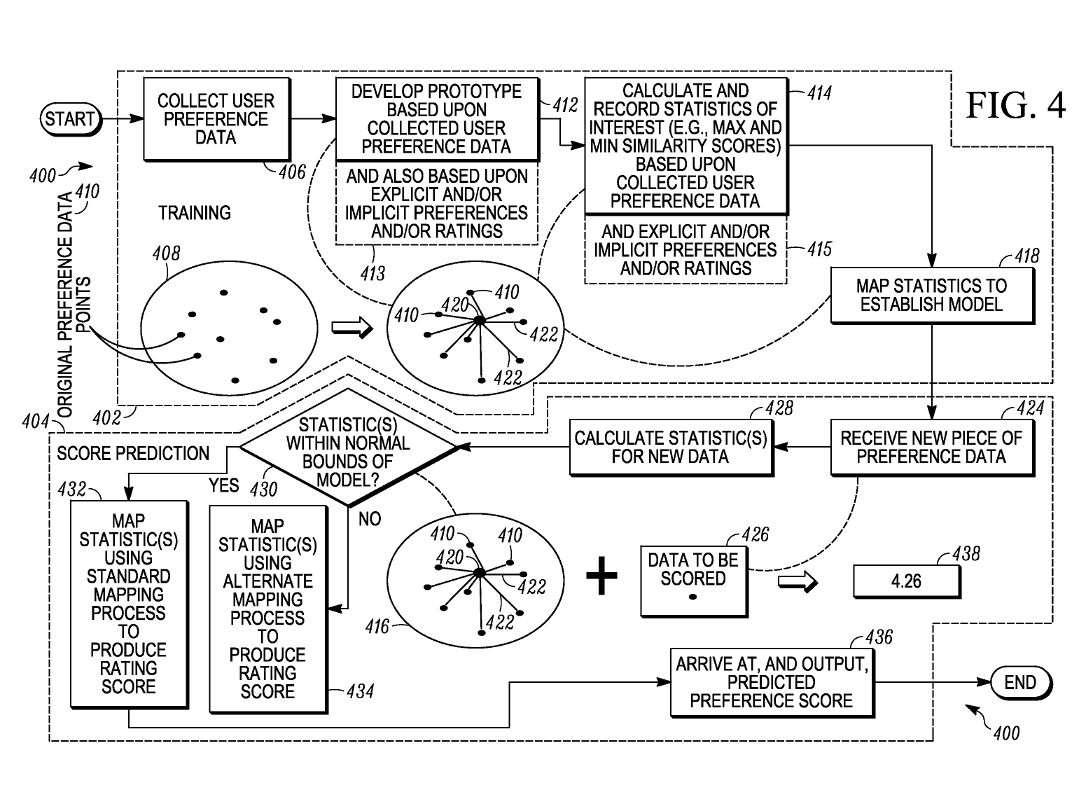

As already mentioned, in at least some embodiments, the present disclosure relates to methods, techniques, models, devices, or systems for assessing preferences or profiles of individuals or users which can be performed by any of the various devices of the communications system 100 of FIG. 1 such as any of the CPWs 106, the intermediate web server 104, any of the mobile devices 102, alone or in combination with one another, or one or more other devices instead of or in addition to such devices of the communication system 100. Referring to FIG. 4, a flowchart 400 illustrates example steps of one such method that can be performed by any of such devices. For simplicity of description below, it is assumed that it is particularly the web server 104 of FIG. 1 that is performing the process steps associated with the flowchart 400. However, it should be appreciated that these process steps can instead or additionally be performed by any of the different devices of the communications system 100, for example, by one of the mobile devices 102 as it monitors selections made by the user who is operating that device 102 or by the CPWs 106 themselves as requests are received or content is transmitted. Indeed, the process steps of the flow chart 400, depending upon the embodiment, can be performed by any of a variety of these or different devices or components, alone or in combination.

As shown, upon commencing at a start step, the process represented by the flowchart 400 includes a series of first steps 402 that relate to training and establishing a preference model (a training subprocess), which is then followed by an additional series of second steps 404 that relate to use of that preference model to conduct score prediction in relation to a newly-received piece of preference data (a score prediction subprocess). Following the series of second steps 404, the process concludes at an end step, albeit it should be appreciated that both the training process corresponding to the first steps 402 and the score prediction process corresponding to the second steps 404 can be performed repeatedly depending upon the circumstance or embodiment. For example, the second steps 404 can be performed repeatedly as additional new pieces of preference data are received, in relation to each of those new pieces of preference data.

As additionally shown in FIG. 4, the training subprocess begins, following the start step, at a step 406, at which the web server 104 collects user-preference data (again, as stated above, in other embodiments another device such as one of the mobile devices 102 can also or instead perform this operation). In the present embodiment, the user-preference data can be access-only data as defined above. For example, the user-preference data can simply be user usage data indicative of a user's selection (e.g., downloading or viewing or consuming) of different content or programming choices (e.g., videos, TV shows, images, games, music, text). The various collected user-preference data are represented in FIG. 4 by a collection 408 of original preference data points 410. Next following the step 406, at a step 412 the web server 104 develops a prototype based upon the collected user-preference data. The prototype is usually constructed from all of the available preference data points and is created on a feature-level. Such a prototype 420 is shown to be present in a modified collection 416, in relation to the preference data points 410. The prototype 420 is a data aggregation that can, in at least some embodiments, capture user preferences, likes, or dislikes. For example, if the prototype 420 relates to movies or videos watched by the user, it could capture which actors or genres are preferred by the user.

Although in the present embodiment the preference data points 410 as well as the prototype 420 pertain to the preferences of a single user, such information can also pertain to multiple users, user groups, users having something in common (e.g., user preferences of users operating multiple different ones of the mobile devices 102 who are using a given service during a particular period of the day), or portions of a single user's data or multiple users' data from a contextual period (e.g., a period of a day, a day of the week, data derived during sunny days, etc.). Further, as additionally represented by a dashed box 413 attached to the box representative of the step 412, in some embodiments or circumstances, development of the prototype 420 is not only based upon the collected user-preference data (e.g., the preference data points 410) but also can be based upon other information including, for example, explicit ratings or preferences, or implicit ratings or preferences (implicitly-derived or inferred preferences). That is, the data used to generate the prototype 420 can include mixed data that includes both collected user-preference data that is access-only data as well as such other types of explicit or implicit data.

In addition to developing a prototype such as the prototype 420 at the step 412, at a subsequent step 414 the web server 104 additionally calculates statistics of interest. These statistics can represent, for example, a distribution of preferences of the preference data points 410 with respect to the prototype 420, as represented by connection links 422 shown in the modified collection 416 in FIG. 4. Statistics that are calculated can take a variety of forms depending upon the embodiment. In at least one embodiment, minimum and maximum similarity scores are calculated as the statistics to describe the preference distribution. As with the development of the prototype 420 at the step 412, the calculating of the statistics at the step 414 can be performed based upon the collected user-preference data (e.g., the data preference points 410). Further, as additionally represented by a dashed box 415 attached to the box representative of the step 414, in some embodiments or circumstances, calculation of the statistics is not only based upon the collected user-preference data but also can be based upon other information including, for example, explicit ratings or preferences, or implicit ratings or preferences (implicitly-derived or inferred preferences). That is, the data used to calculate the statistics can include mixed data that includes both collected user-preference data that is access-only data as well as such other types of explicit or implicit data.

Upon the calculation of the statistics (e.g., minimum and maximum similarity scores), the scores for other statistics can be mapped, at a step 418, to establish a preference model, the mapping of the step 418 can also be referred to as “redistributing.” The modified collection 416 can be ultimately considered to represent such a preference model. In the present example in which the statistics that are calculated at the step 414 are similarity scores, such calculations particularly involve computing similarity scores between each preference data point 410 in the user-preference data collection 408 relative to the prototype 420 that is developed at the step 412. Further, upon the calculations being performed, the mapping performed at the step 418 involves recording the maximum and minimum possible similarity scores which are respectively then referred to as max_sim and min_sim. Recording of the minimum possible and maximum possible similarities statistics provides an insight into how much is known about the user via the data and, by virtue of the mapping performed at the stop 418, provides a framework for distributing the scores in a meaningful way relative to the amount and informativeness of the data that are available.

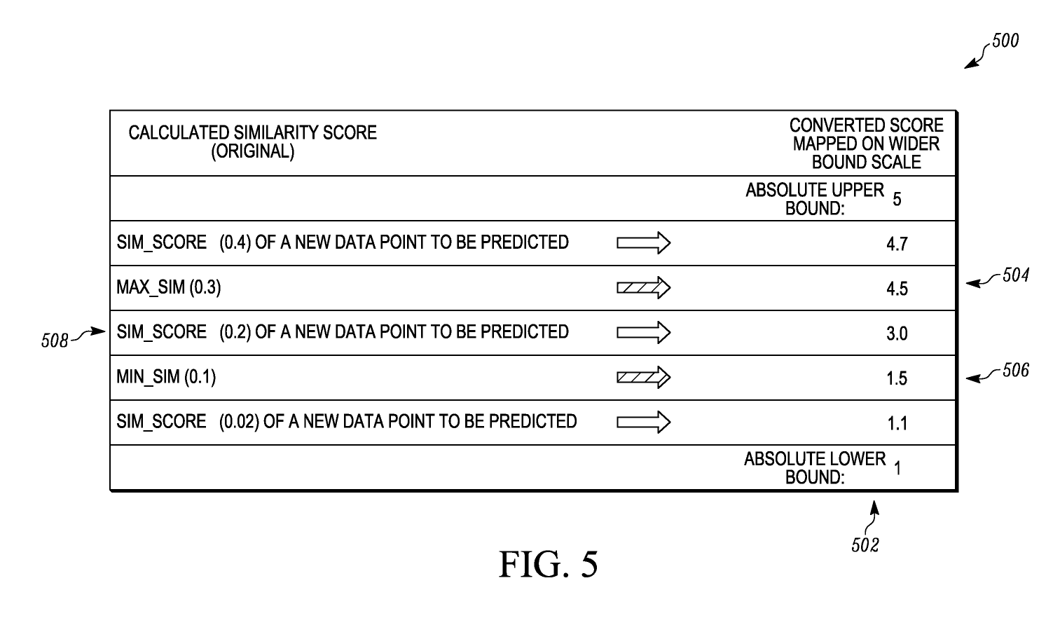

The mapping performed at the step 418 particularly in some embodiments involves a redistribution of similarity scores to allow for the establishment of the model usage component (preference model) that can later be used for score prediction during the second steps 404. For example, in the present embodiment in which the max_sim and min_sim statistics are recorded, these statistics are particularly mapped onto a pre-defined wider-bound redistributed scale having higher and lower bound redistributed scores that are respectively above and below the max_sim and min_sim values. For example, assuming the wider-bound redistributed scale is a one to five rating scale, the max_sim value can be established as the pre-defined higher-bound redistributed score (e.g., 4.5 out of 5 on the 1 to 5 rating scale), and the min_sim value can be mapped onto the wider-bound redistributed scale as the lower-bound redistributed score (e.g., 1.5 on a 1 to 5 rating scale). For purposes of illustration, FIG. 5 is a chart 500 illustrating a wider-bound scale 502 having an absolute upper bound of 5 and an absolute lower bound of 1. Given this wider-bound scale 502, similarity scores and statistics calculated at the step 414 are mapped onto the scale so as to establish a higher-bound redistributed score 504 and a lower-bound redistributed score 506. That is, in the present example, a value of 0.3 that is calculated as the max_sim value is mapped and converted to a value of 4.5 that is the pre-defined higher-bound redistributed score 504 on the wider-bound scale 502, while a minimum similarity score min_sim of 0.1 is mapped to a value of 1.5 that is the lower-bound redistributed score 506 on the wider-bound scale 502. As will be discussed in further detail with respect to the score prediction second steps 404, by establishing the higher and lower bound distributed scores 504 and 506, respectively, semantically meaningful rating scores can be attained for newly received pieces of preference data.

Upon the completion of the step 418, the training process first steps 402 are completed, and the process 400 advances to the score prediction second steps 404, particularly initially to a step 424 at which the web server 104 receives a new piece of preference data, shown in FIG. 4 as a data point 426. In order for that preference data (data point 426) to be scored, a variety of subsequent steps are performed to accomplish the score prediction. As shown, subsequent to the step 424, a step 428 is performed in which statistics are calculated by the web server 104 with respect to the new reference data point (or simply new data point) 426. In the present embodiment, the web server 104 at this step particularly calculates a similarity score for the new data point 426, where the similarity score is between the data point and the prototype. When applying the preference model to infer a scored preference for the newly-received data point 426 (e.g., during a prediction effort), it is assumed that the distribution represented by the model arrived at by way of steps 412, 414, and 418 is applicable and appropriate for that new data point 426 (that is, it is assumed that the similarity score to the prototype 420 is assumed to follow the same distribution). Assuming this to be the case, a mapping function is used to redistribute the similarity score determined at the step 428 into a model such as the model represented by the wider-bound scale 502 (in which five can be understood to indicate strong preference and one can be assumed to indicate strong dislike).

The exact manner of applying the preference model to infer a scored preference or ranking for a newly-received data point such as the new data point 426 can vary depending upon the embodiment. More particularly, in the present embodiment, after the similarity score has been calculated at the step 428, the web server 104 performs additional steps 430, 432 or 434, and 436 to determine and output a score prediction. More particularly, in the present example in which similarity scores are calculated, and the wider-bound scale 502 is established and utilized, the web server 104 upon calculating the similarity score for the new data point 426 at the step 428 first determines whether the similarity score falls within the normal bounds of the model, that is, within the range established between the lower-bound distributed score 506 and the higher-bound redistributed score 504 of the wider-bound scale 502. If the similarity score is within the normal bounds, that is, between the lower-bound and higher-bound redistributed scores 506 and 504, then the process advances from the step 430 to a step 432, at which the web server 104 then maps the statistics (that is, the calculated similarity score) using a standard mapping process to produce the ratings score.

For example, a linear or polynomial function can be used to map the calculated similarity score (calculated at the step 428) onto the wider-bound scale 502. An example of such a mapping is shown in the chart 500 of FIG. 5, which shows that a calculated similarity score sim_score 508 is mapped to a value of 3.0 on the wider-bound scale 502. In the present example, the similarity score sim_score of the new data point 426 is calculated at a similarity score of 0.2, which happens to be exactly in-between the similarity score values corresponding to the min_sim and max_sim values (0.1 and 0.3, respectively). Thus, the score to which the similarity score sim_score 508 is mapped is 3.0, which is exactly in-between the lower-bound redistributed score 506 and the upper-bound redistributed score 504.

Alternatively, it is possible that in some cases the statistics (e.g., similarity score) calculated for the new data point 426 at the step 428 will be outside the normal bounds of the model. For example, assuming that the wider-bound scale 502 shown in FIG. 5 is the model being applied in relation to similarity score values, it is possible that the web server 104 will calculate the similarity score for the new data point 426 to be above or below the values of max_sim and min_sim utilized at the step 418 to establish the model. For example, as further shown at FIG. 5, the new data point 426 can have a calculated similarity score of 0.4, which is above the value of max_sim (0.3), or can have a value of 0.02, below the value of the min_sim (0.1), to which are ascribed the upper-bound redistributed score 504 at 4.5 and the lower-bound redistributed score 506 of 1.5. In this circumstance, a calculated similarity score that is above the max_sim value will be mapped onto a redistributed score that is between the higher-bound redistributed score 504 and the absolute upper bound of the wider-bound scale 502, namely, between 4.5 and 5, while a calculated similarity score below the min_sim value will be mapped onto a redistributed score between the lower-bound redistributed score 506 corresponding to min_sim (1.5) and the absolute lower bound 1 of the wider-bound scale 502, namely, between 1.5 and 1. Again, for example, a linear or polynomial function can be used for such mapping. Thus, in the present example shown in FIG. 5, where the similarity score sim_score of the new data point 426 is determined to be 0.4, the mapping process results in that new data point receiving a predicted score of 4.7, while where the similarity score sim_score of the new data point is determined to be 0.02, the predicted score on the wider-bound scale 502 is 1.1.

Thus, the step 434 leaves space in the model for data points that exceed the maximum or minimum thresholds, thus leaving the scores once again well distributed (well-ranked). In either case, regardless of whether the calculated statistics (e.g., similarity scores) established at the step 428 are within or without the normal bounds of the model as determined at the step 430, such that either the steps 432 or 434 are performed, the process then proceeds from either the step 432 or the step 434 to a step 436, at which the predicted score is arrived at and output as appropriate, and then the process ends at the end step. The processes described in relation to FIGS. 4 and 5 is advantageous in a variety of respects. In particular, use of such processes makes it possible to overcome the limitations of preference models which only produce similarity scores that are not meaningful beyond ranking. That is, in at least some embodiments, use of such processes allows for similarity scores to be converted and distributed into scores on a semantically meaningful rating scale so that a data point can be easily categorized and communicated, where the distribution of the scored items aligns with expected results. Doing so allows the scores to be both easily interpreted and relied on for further computation.

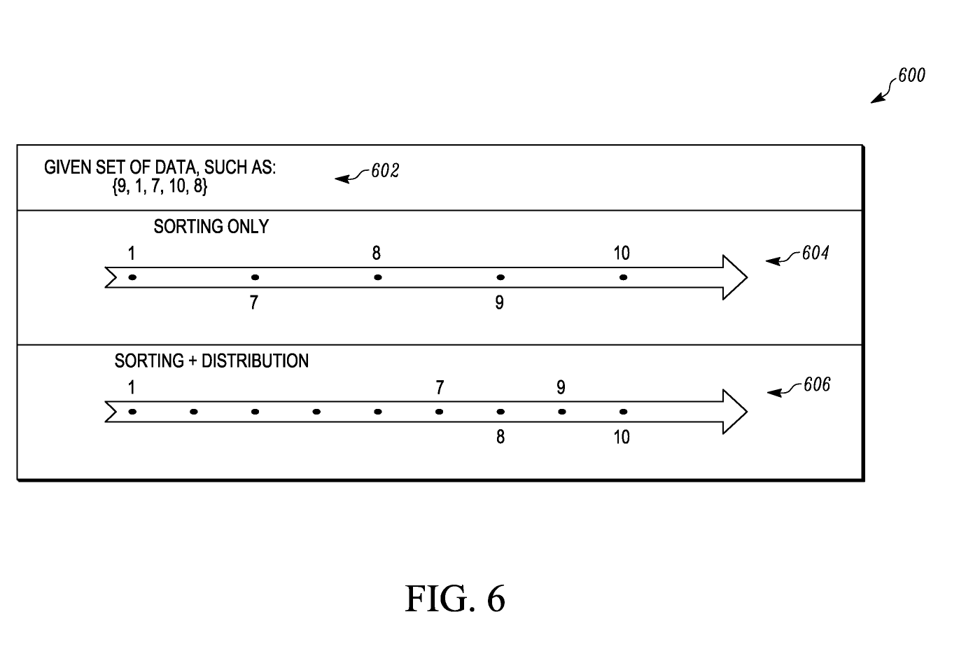

FIG. 6 provides a further schematic illustration of the advantages provided using processes such as those of FIGS. 4 and 5. As shown, given a set of data points to be considered 602 (which for illustrative purposes are shown simply as integers with values between 1 and 10), use of the processes such as those of FIGS. 4 and 5 allows not only for sorting of the data points as represented along a ranking line 604 but also allows for determining a relative distribution of the data points as represented along a ranking line 606. Thus, while sorting alone merely allows for determining and communicating whether each of the data points is greater than or lesser than the other data points of the set 602, sorting supplemented by distribution also allows for determining and communicating the relative spacing between different data points. Such spacing information further allows for the discernment of trends in the distribution and strength of different preferences and allows preference information to be easily categorized and communicated where the distribution of the scored items aligns with expected results. Such information can be utilized in a variety of circumstances where user-preference models are of interest including, for example, in establishing user profiles and models, in conducting searching and profiling activities, and in operating prediction or recommender systems in relation to a variety of types of information and content (e.g., video, music, advertisements, news, and the like).

In short, techniques such as that described above with reference to FIGS. 4 through 6, in which preference models store a prototype extracted from available user-behavior data as well as some additional statistics which are computed based on the similarity scores between each data point from a user's history and such a prototype (and which represent the distribution of similarity scores of each preference data point with respect to the prototype), allow for the establishment of preference models that are relatively compact and have improved scalability (e.g., in terms of allowing scaling to account for large amounts of user-behavior data) by comparison with preference models that store user-behavior data directly. The statistics particularly describe the distribution of user preferences with respect to the prototype by recording the possible similarities given the data set (again, for example, in the current embodiment, the minimum possible and maximum possible similarity statistics are used, albeit additional or different statistics could be used in other embodiments). The distribution information about similarity scores particularly can provide some critical thresholds (for example, maximum, minimum, mean, or median), which specify the possible range of similarity scores that any data points can have. A mapping function which utilizes these critical thresholds can map and redistribute similarity scores to scores on a semantically meaningful rating scale, so as to develop a semantically meaningful rating score (again, for example, a rating scale from 1 to 5, where 5 indicates strong preference and 1 strong dislike). As a result, the redistributed scores are both easily interpreted and relied on for further computation, and this type of technique offers a principled manner of inferring scored preferences based on preference models built on accessed data. That is, when a preference model built upon access-only data is used to infer a user's preference on any data point (e.g., during prediction), the above-described technique can be applied to infer a score for the data point which directly indicates whether such a data point would be preferred by users.

Even with such techniques, however, updating the preference model with new data can also be problem in terms of efficiency, because statistics may need to be calculated with reference to all of the data points from which the model is derived. This being the case, the present disclosure further envisions the implementation, in at least some embodiments or circumstances, of a method to efficiently update such preference models, as new user-behavior data are collected, by incrementally updating the prototype and related statistics based on those newly collected behavior data (and, in at least some such embodiments, based only on those newly collected behavior data). Through the use of such a method, it is possible to avoid looking through all the previous user-behavior data, and thus possible to update the preference models more efficiently than would otherwise be the case. As with the techniques described with respect to FIGS. 4 through 6, such methodologies for efficient updating can be employed in a variety of embodiments and circumstances including, for example, as part of a recommendation or user modeling, profiling, and personalization technologies that can be implemented for example on any one or more of the devices of FIG. 1 alone or in combination with one another or other devices (e.g., on the web server 104 or any of the mobile devices 102).

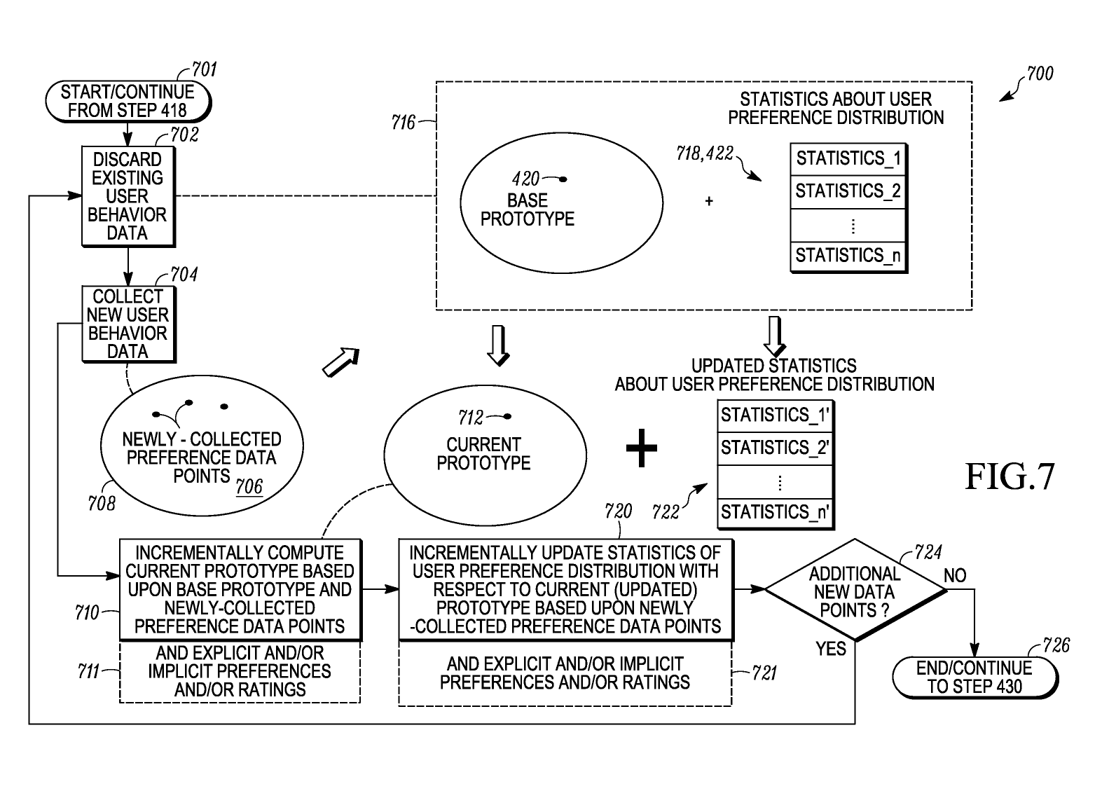

Turning to FIG. 7, an additional flow chart 700 shows steps of an example of one such methodology for efficient updating. As can be appreciated from the above discussion, the process of the flow chart 700 at a start step 701 begins with an existing or base prototype and existing statistics having already been determined based upon existing (past) collected user-preference data, for example, in accordance with the flow chart 400 of FIG. 4. Thus, the start step 701 can actually represent merely a continuation from the flow chart 400, for example, from the step 418 thereof. Upon starting with this information, at a step 702 the existing collected preference data (for example, the original preference data points 410 of FIG. 4) that were utilized to develop the original or base prototype and existing statistics are first discarded at a step 702. However, the original prototype and already-calculated statistics are retained as original data 716. Thus, assuming for example that the original preference data points 410 were utilized to determine the prototype 420 and statistics represented by the original connection links 422, the original data 716 retains the prototype 420 (which is the original or base prototype in this example) as well as statistics 718 that correspond to the connection links 422.

Following the step 702, next at a step 704 one or more new preference data points (e.g., new user-behavior data) 706 are collected, which can be considered a collection 708. Further, at a step 710, a new or updated prototype, which is hereinafter referred to as a current prototype 712, is incrementally computed based upon the base prototype 420 and the new preference data points 706 newly-collected at the step 704. In at least some embodiments, the incremental computation is performed in such a manner that only the new preference data points 706 are used to perform the computation (since the original preference data points 410 were discarded at the step 702, these are not used for this computation). Then, at a step 720, additionally the statistics 718 concerning user-preference distribution are incrementally updated with respect to the current (updated) prototype 712 based upon the new preference data points 706, so as to generate updated statistics 722. Again, in at least some embodiments, the incremental computation is performed in such a manner that only the new preference data points 706 (but not any other data points such as the original preference data points 410) are considered in the computation.

Further, as additionally represented by a dashed box 711 attached to the box representative of the step 710 and a dashed box 721 attached to the box representative of the step 720, in some embodiments or circumstances, the incremental computing of the current prototype at the step 710 or the incremental updating of the statistics at the step 720 can be performed not only based upon the newly-collected user-preference data (e.g., the new preference data points 706) but also can be based upon other information including, for example, explicit ratings or preferences, or implicit ratings or preferences (implicitly-derived or inferred preferences). That is, the data used to generate the current prototype 712 as well as the data used to generate the update statistics 722 can include mixed data that include both collected user-preference data that are access-only data as well as such other types of explicit or implicit data.

It will be appreciated that the steps described above with respect to the flow chart 700 can be performed over and over again as additional new data are collected over time. Thus, following the step 720, a step 724 is performed and, if there are additional new data points that were collected, then the steps 702, 704, 710, and 720 are performed again, and, if not, the process ends at an end step 726. Further as indicated, in at least some embodiments the end step 726 can merely be a transition step after which another step such as the step 430 (or the steps 424 or 428) of FIG. 4 is performed.

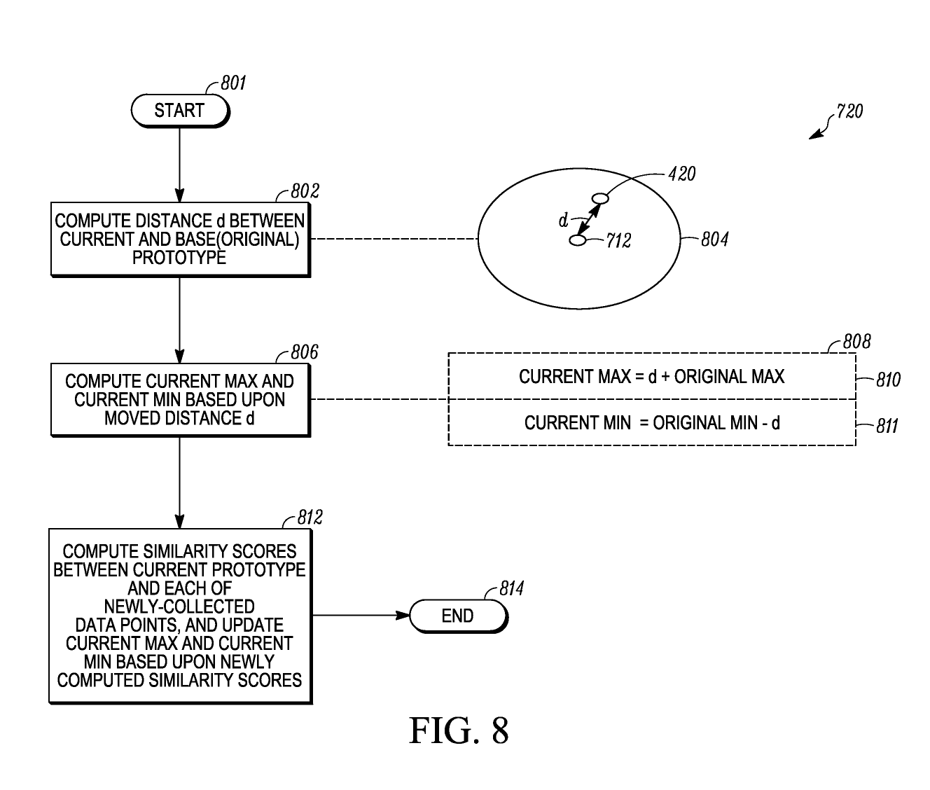

Referring additionally to FIG. 8, example substeps corresponding to the step 720 of FIG. 7 are additionally shown. In this particular example embodiment, upon the step 720 starting at a start substep 801, at a substep 802 a moved distance d between the current prototype 712 and the base prototype 420 is computed. This d is figuratively represented in a collection 804 associated with the step 802, as the distance that the base prototype 420 moves to become (and to have the same position as) the current prototype 712 in that collection. Next, at a substep 806, current max and current min values are calculated as also represented by a calculation box 808. The current max value is particularly computed by adding the moved distance d to the original max value (as represented in a calculation portion 810), and the current min value is computed by subtracting the moved distance d from the original min value (as represented in a calculation portion 811). Finally, after the substep 806 is performed, then at a substep 812 similarity scores are further calculated between the current prototype 712 and each of the newly collected data points 706 (see FIG. 7), and the current max and current min values are further updated based upon these newly computed similarity scores. The substeps corresponding to the step 720 of FIG. 7 then are complete, as indicated by an end step 814.

As indicated above, the methodologies and processes described above have a variety of possible applications. For example, such methodologies and process can be employed in developing user profiles or models in a recommender system that utilizes access-only data, which is the most common type of data access, for recommending video, music, advertisements, news, and the like, that are in use or being considered for use in various businesses. The methods and processes in at least some embodiments provide more sophisticated and differentiated user-preference models (recommender, profiler and search) which can always produce semantically meaningful scores regardless of the type of preference data, and through the use of these methods and processes users can better understand the results (e.g., in terms of star-ratings), and the computation based on the results is also more accurate.

Further, as discussed above, in at least some embodiments, the presently-disclosed methods and processes do not store user-behavior data for updating user-preference models. Rather, as new user-behavior data are collected, the prototype is incrementally updated based on the new behavior data only. Then, based on the changes between the previous prototype and the updated prototype, additional statistics about the distribution of user preferences with respect to the update prototype are further updated. The time spent on updating the preference model, including both the prototype and additional statistics, only depends on the amount of newly collected user-behavior data, which makes the proposed algorithm scale to arbitrary amounts of user-behavior data.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of ascribing a score to a first portion of preference data, the method comprising:
establishing a model of user-preference data;
receiving the first portion of preference data at a first computerized device and storing the first portion of preference data in a memory device associated with the first computerized device;
calculating at least one statistic in relation to the first portion of the preference data by way of a processing device of either the first computerized device or a second computerized device in communication with the first computerized device; and
performing at least one additional operation, by way of either the processing device or another processing device, by which the at least one statistic is evaluated in relation to the model;
whereby as a result of being evaluated, the at least one statistic is converted into the score.

2. The method of claim 1 wherein the at least one additional operation includes at least one mapping operation, and wherein the first computerized device is selected from the group consisting of: a mobile device, a content provider website, and a server.

3. The method of claim 1 wherein the at least one statistic includes a similarity score.

4. The method of claim 3 wherein the at least one additional operation includes a first operation by which it is determined whether the similarity score is within a normal range of the model or outside the normal range of the model.

5. The method of claim 4 wherein when the similarity score is determined to be within the normal range, the at least one additional operation includes applying a function to the similarity score by which the similarity score is converted into the score, wherein when the score is within a standard range of a scale, the standard range being bounded by higher and lower bounds corresponding respectively to maximum and minimum similarity scores associated with at least one additional portion of data that was considered in the establishing of the model, and wherein the higher bound is less than a maximum upper bound of the scale, and the lower bound is greater than a minimum lower bound of the scale.

6. The method of claim 1 wherein receiving, calculating, and performing are repeated in relation to at least one additional portion of the preference data.

7. The method of claim 1 wherein establishing includes:
collecting a plurality of additional portions of preference data; and
developing a prototype based upon the additional portions of preference data;
wherein the prototype is a data aggregation based, at least in part, upon each of the additional portions of the preference data.

8. The method of claim 7 wherein establishing further includes:
calculating at least one further statistic in relation to each respective one of the additional portions of preference data; and
performing at least one mapping operation in relation to the further statistics so as to complete the establishing of the model.

9. The method of claim 8 wherein the at least one further statistic in relation to each respective one of the additional portions of preference data includes a respective maximum similarity score and a respective minimum similarity score.

10. The method of claim 8 further comprising:
performing an updating operation by which each of the prototype and one or more of the at least one further statistic are modified based upon a further portion of the preference data but not upon the additional portions of preference data.

11. A method of establishing a preference model that can be utilized for ascribing a score to a first portion of preference data, the method comprising:
collecting a plurality of first portions of preference data at a first computerized device and storing the portions of preference data in one or more memory devices associated with the first computerized device;
developing a first prototype based upon the portions of preference data, wherein the prototype is a data aggregation based, at least in part, upon each of the portions of the preference data;
calculating, by way of a processing device of the first computerized device, at least one first statistic in relation to each respective one of the portions of preference data; and
performing at least one mapping operation in relation to the statistics so as to complete the establishing of the preference model.

12. The method of claim 11 further comprising one or both of:
(a) updating the preference model based upon one or more additional portions of preference data; and
(b) ascribing a score to the one or more additional portions of the preference data based at least in part upon the preference model.

13. The method of claim 12 wherein the method includes (a) and wherein the updating of the preference model further includes:
receiving the one or more additional portions of the preference data;
computing an updated prototype based upon the one or more additional portions of the preference data; and
computing at least one updated statistic based upon one or more of the first statistics and the one or more additional portions of the preference data.

14. The method of claim 13 wherein the computing of the at least one updated statistic includes each of: computing a distance between the first prototype and the updated prototype, computing at least one new bound value based upon a previous bound value and the distance, and computing a respective similarity score between the updated prototype and each of the one or more additional portions of the preference data, respectively, and updating the at least one new bound value based upon the computed similarity score or scores.

15. The method of claim 12 further comprising:
receiving the one or more additional portions of the preference data at the first computerized device and storing the one or more additional portions of the preference data in the memory device;
calculating at least one statistic in relation to the one or more additional portions of the preference data by way of either the first processing device or a second processing device; and
performing at least one additional operation, by which the at least one statistic is evaluated in relation to the model;
whereby as a result of being evaluated, the at least one statistic is converted into a score.

16. A system configured for processing access-only user-behavior data, the system comprising:
at least one input device by which a plurality of first preference data portions is received;
at least one memory device at least indirectly coupled to the at least one input device, the at least one memory device being configured to store the first preference data portions; and
at least one processing device at least indirectly coupled to each of the at least one input device and the at least one memory device, the at least one processing device being configured to determine a first prototype based upon the first preference data portions and further configured to determine a plurality of first statistics in relation to the first preference data portions;
wherein based upon the first prototype and the first statistics a scoring scale is developed by which similarity scores can be converted based upon further processing of the at least one processing device to have semantically meaningful scores.

17. The system of claim 16 wherein the system includes one or more of at least one mobile device, at least one web server, and at least one content provider system, and further comprising at least one output device at which the semantically meaningful scores are output.

18. The system of claim 16 wherein one or more of the first prototype and the plurality of first statistics are additionally determined based upon one or more of explicit rating information, explicit preference information, implicit rating information, and implicit preference information.

19. The system of claim 16 wherein the processing device is further configured to operate to determine whether a first of the similarity scores is within a normal range within a scale or outside of the normal range along the scale and to perform a conversion operation in a different manner based upon whether the first of the similarity scores is within the normal range or outside of the normal range.

20. The system of claim 16 wherein the processing device is further configured to update the first prototype to arrive at an updated prototype based upon at least one additional preference data portion and also, based at least in part upon a distance between the first prototype and the updated prototype, configured to update the first statistics based upon the at least one additional preference data portion.

21. The system of claim 20 wherein one or more of the first prototype and the first statistics are additionally updated based upon one or more of explicit rating information, explicit preference information, implicit rating information, and implicit preference information.
